(19) United States
(12) Patent Application Publication
(10) Pub. No.: US 2012/0003366 A1
(43) Pub. Date: Jan. 5, 2012

(54) AUTOMATED EQUIPMENT FOR HYDRATION, MIXING AND DELIVERY OF ALGINATE TO A PELLET FORMING DEVICE

(75) Inventors: Bruce Dorendorf, Winnebago, MN (US); Brian Caldwell, Mapleton, MN (US); Scott H. Hislop, Winnebago, MN (US); Bruce Larson, Fairmont, MN (US)

(73) Assignee: American Bio Labs, LLC, Mapleton, MN (US)

(21) Appl. No.: 13/175,645

(22) Filed: Jul. 1, 2011

Related U.S. Application Data
(60) Provisional application No. 61/361,115, filed on Jul. 2, 2010.

(51) Int. Cl. A23L 1/00; B29C 47/92

(52) U.S. Cl. 426/285; 425/145; 425/144; 425/140

(57) ABSTRACT

The present invention provides methods and devices for the preparation and delivery of retention and lubricant agents to ingredients to be pelletized through a forming device such as a pellet mill, extruder or otherwise. Through the features of the present invention, a continuous supply of retention and lubricant agent is prepared and delivered to a forming device, which may be automated based upon calculated or measured need of the retention and lubricant agent. In one embodiment, these and other advantageous features are based upon a unique device configured for automated hydration and delivery of alginate to a forming device based upon one or more conditions of the device, forming device or both.

### CLAIM OF PRIORITY

The present application claims priority to U.S. Patent Application No. 61/361,115, to Dorendorf et al., filed Jul. 2, 2010, the contents of which are hereby incorporated by reference in its entirety for all purposes.

### CROSS-REFERENCE TO RELATED APPLICATION

The present application is related to U.S. patent application Ser. No. 11/768,446, to Fajt et al., filed Jun. 26, 2007, now U.S. Patent Publication No. 2007/0298082, the contents of which are hereby incorporated by reference in its entirety for all purposes.

### FIELD OF THE INVENTION

The present invention relates to methods and devices for the preparation and delivery of retention and lubricant agents to ingredients to be pelletized through a forming device such as a pellet mill, extruder or otherwise.

### BACKGROUND

Forming devices, such as pellet mills, extruders or otherwise, provide a continuous production of individual articles, such as pellets, for various applications including animal feed, plant food, bio-fuel or otherwise. With the continual production of articles, it is important to ensure the availability of ingredients used to form the articles. For example, ingredients used to form the articles may be housed within a hopper or otherwise continually fed to the forming device. Also, in certain configurations, steam or other ingredients are applied or added to the ingredients during formation.

In commonly owned U.S. Patent Publication No. 2007/0298082, described above, the use of alginates as a lubricant and retention agent is taught. This publication teaches methods for the introduction of processed alginate to ingredients for the purpose of lubrication and retention of the resulting articles. The publication further teaches that the introduction of processed alginate may be performed before, during and/or after forming of the articles.

In view of the foregoing, there is a need for methods and devices for processing and delivery of alginate to forming devices to provide lubrication and retention to ingredients being formed into articles (e.g. pelletized, or otherwise), and to maintain operation of the forming device, with little to no interruption. Further, there is a need for automated processing and delivery of alginate to forming devices based upon one or more conditions of the forming device to ensure optimum application of processed alginate to the ingredients forming the articles, to increase efficiency of the forming device, to increase tool life of the forming device and decrease production cost of the articles.

### SUMMARY OF THE INVENTION

The present invention provides methods and devices for the preparation and delivery of retention and lubricant agents to ingredients to be pelletized through a forming device such as a pellet mill, extruder or otherwise. Through the features of the present invention, a continuous supply of retention and lubricant agent is prepared and delivered to a forming device, which may be automated based upon calculated or measured need of the retention and lubricant agent. In one embodiment, these and other advantageous features are based upon a unique device configured for automated hydration and delivery of alginate to a forming device based upon one or more conditions of the device, forming device or both.

In view of the foregoing, in one exemplary embodiment, the present invention provides an alginate hydration, storage and dispensing system for a pellet forming device. The system includes a storage and dispense system for receiving and dispensing dry alginate. The storage and dispense system includes a drive mechanism for dispensing dry alginate through a dispense port. The system further includes a mixer assembly disposed proximate and below the dispense port. The mixer assembly includes a container including an annular wall and a base. The container includes a hydration port for receiving fluid from a water supply and a mixture port for dispensing mixture from within the container. The mixer assembly further includes a rotatable partition wall disposed within the container. The partition wall defines a first chamber formed within the partition wall and a second chamber formed between the annular wall and partition wall, wherein the partition wall is displaced with respect to the base of the container to form a fluid flow path between the first and second chamber. The mixer assembly further includes one or more fin members extending radially about a center portion of the partition wall and towards the fluid flow path. The mixer assembly also includes a mixer motor linkably engaged with the partition wall to cause rotation of the one or more fin members, wherein upon rotation the one or more fin members are configured to generate a fluid vortex within the first chamber to cause mixture within the first chamber and fluid movement from the first chamber to the second chamber. The system further includes a reservoir in fluid communication with the mixture port of the container to receive fluid from the second chamber. The system further includes a positive displacement pump in fluid communication with the reservoir to pump fluid from the reservoir to a pellet forming device. The system still further includes a controller in communication with the drive mechanism, mixer motor and positive displacement pump, wherein the controller activates the drive mechanism to dispense dry alginate based upon fluid level within the reservoir to provide continuous supply of mixture for the positive displacement pump.

In another exemplary embodiment, the present invention provides a method of providing a continuous supply of hydrated alginate to a forming device. The method includes the steps of providing a source of dry alginate; providing a source of hydration fluid; and providing a mixer assembly including: a container defined by an annular wall and a base, the container including a dispensing port for dispensing a fluid mixture to a reservoir which is in fluid communication with a fluid pump, a partition wall disposed within the container, the partition wall defines a first chamber formed within the partition wall and a second chamber formed between the partition wall and annular wall, one or more fin members disposed about a center portion of the partition wall and within the first chamber. The method further includes the steps of dispensing dry alginate and hydration fluid into the first chamber of the container; rotating the partition wall to generate a fluid vortex within the first chamber to cause mixing of the dry alginate and hydration fluid to form a fluid mixture and generate movement of the fluid mixture from the first chamber to the second chamber and further through the dispensing port and to the reservoir; and pumping the fluid mixture from the reservoir to the forming device.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates a schematic view of an exemplary embodiment of a hydration, mixing and delivery system of the present invention in communication with a water supply, alginate supply and forming device;

FIG. 2 illustrates a schematic view of an exemplary embodiment of a controller of a hydration, mixing and delivery system of the present invention;

FIGS. 3 and 4 illustrate different perspective views of an exemplary hydration, mixing and delivery system of the present invention;

FIG. 5 illustrates a perspective view of a mixer assembly according to an exemplary embodiment of the present invention;

FIG. 6 illustrates a cross-sectional view of the mixer assembly shown in FIG. 5;

FIG. 7 illustrates a cross-sectional view of the mixer assembly shown in FIG. 5; and

FIG. 8 illustrates a cross-section view of a reservoir according to an exemplary embodiment of the present invention.

### DESCRIPTION OF THE PREFERRED EMBODIMENTS

In general, the present invention relates to methods and systems for the formulation of lubricant and retention agents for application to ingredients to be pelletized through forming devices, such as extruders, pellet mills or otherwise. As described in commonly owned U.S. Patent Publication No. 2007/0298082, it has been discovered that alginate, such as sodium alginate or otherwise, provide advanced lubrication and retention capabilities to ingredients being formed. Through the use of alginates, increased pressure can be applied to ingredients resulting in increased production rate and reduced tool wear. In particular, the use of alginates has been discovered to be particularly advantageous in the pelletization of ingredients.

The present invention continues the advancements shown and described in U.S. Patent Publication No. 2007/0298082 by providing unique methods and systems for the preparation/processing, storage and delivery of alginate to a forming device, such as a pellet mill, extruder or otherwise. The system includes a unique mixing system for hydration of dry alginate. The system further includes unique delivery system for delivery of the hydrated alginate to a forming device. In another aspect, the present invention provides the ability to automatically adjust or control various components of the system based upon operation conditions of the system, forming device or both in order to optimize production of articles, i.e. pellet, article quality being formed by the forming device and increase tool (e.g., die or otherwise) life. In doing so, the system is able to adjust operating conditions of the system based upon such factors as: specific ingredients being pelletized, forming rate of articles by the forming device, type of alginate and/or additives being utilized, temperature of water being used to hydrate the alginate or otherwise. The system is able to continually modify the production and delivery of alginate to the forming device to maximize production and quality of articles being formed. Other features will be appreciated as shown and described herein.

It is contemplated that the methods and systems shown and described herein may be used to form different articles, such as pellets or otherwise, for various applications, which may naturally include various ingredients. For example, it is contemplated that the methods and devices may be used for the production of articles for animal feed or medicine such as poultry (e.g., turkey, chickens, etc.), swine, ducks, sheep, horses, cattle, rabbits, dogs, cats, fish, invertebrates and other warm or cold blooded animals. It is also contemplated that the methods and devices may be used for the production of plant additives such as fertilizers, fungicides, herbicides, insecticides or otherwise. It is further contemplated that the methods and devices may be used for the production of bio mass articles such as fuel, liquid absorbent material or otherwise. Still further, it is contemplated that other articles may be formed.

In accordance with the above applications, with respect to animal feed ingredients, it is contemplated that the methods and devices may be used to form articles including: corn, soybeans, wheat, oats, animal fats, oils, rye, barley, urea, vitamins, minerals, medicines, distillers, amino acids, whey, alfalfa, fish meal, bone meal, animal by-products, canola, sunflower, vegetable oils, fruit or vegetables, seed material, proteins, bakery products, yeast, algae, limestone, dicalcium phosphate, antibiotics, growth promoters, acidifiers, ractoponine, glycerin or otherwise. With respect to plant additive ingredients, it is contemplated that the methods and devices may be used to form articles including: nitrogen, phosphates, ash, magnesium, potassium, iron, potash, copper, nitrates, zinc, cobalt, and other natural and/or synthetic materials. Yet other potential ingredients include: Shredded wood, saw dust, carbon dust, plant husk, seeds, algae, switch grass, limestone, other pelletable materials or otherwise.

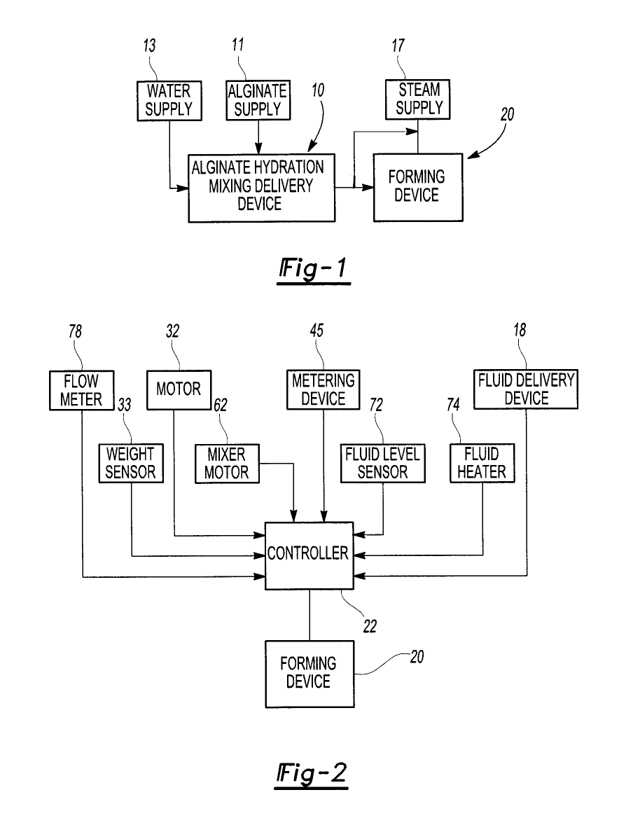

In general, referring to FIGS. 1 through 4, the present invention provides an alginate hydration, storage and dispensing system 10 for the preparation and application of alginate to ingredients to be pelletized or otherwise formed. The system 10 includes an alginate storage and dispense system 12 for the storage of dry alginate from an alginate supply 11, prior to mixing; a mixer assembly 14 for hydration and mixing of the dry alginate with a fluid supply such as water from a water supply 13 to form a hydrated alginate mixture 15; a reservoir 16 for storage of the hydrated alginate; a fluid delivery device 18 for delivery of the hydrated alginate to a forming device 20; and a controller 22 to control functions of the system 10.

In operation, dry alginate is placed within the dry alginate storage and dispense system 12. The dry alginate is dispensed into the mixer assembly 14 where it is hydrated, mixed and delivered to reservoir 16. The reservoir 16 provides hydrated alginate to the fluid delivery device 18, wherein upon activation of the delivery device, a continuous supply of hydrated alginate is supplied to the delivery device 18 through the reservoir 16. Operation of the system 10 is automatically controlled by the controller 22 based upon conditions of the system 10, conditions of the forming device 20 or both.

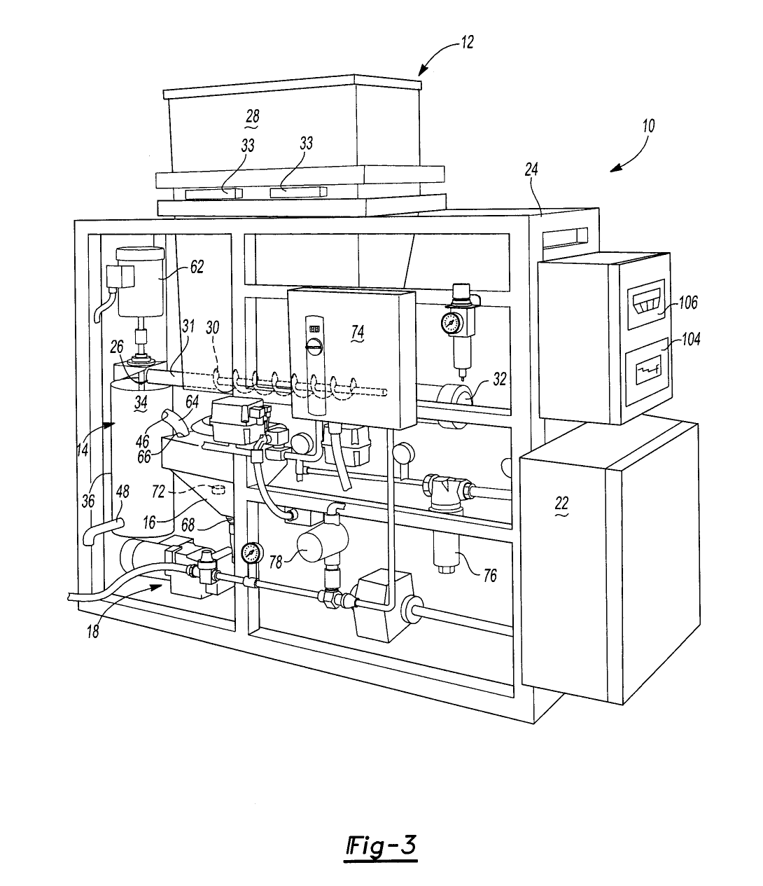

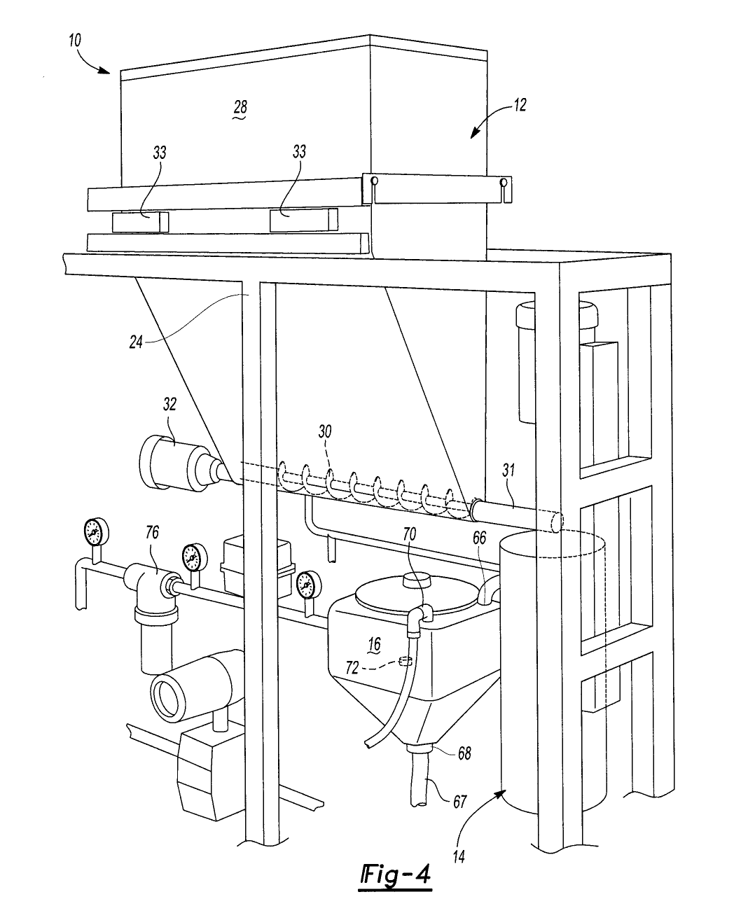

In greater detail, referring to FIGS. 3 and 4, the dry alginate storage and dispense system 12 is configured to provide metered dry alginate to the mixer assembly 14. In one embodiment, the system is supported by a frame assembly 24 and includes a dispense port 26 disposed proximate, and in one configuration over, the mixer assembly 14. The system 12 includes a hopper 28 for storage of dry alginate. The hopper 28 includes an auger 30 for movement of the dry alginate to the dispense port 26. The auger is powered through a motor 32, which is configured to provide incremental movement of the auger and hence dispensing of the dry alginate. In one particular configuration, a conduit 31 is provided for disposing the dispense port 26 away from the system 12 and over the mixer assembly 14.

Dispensing of the dry alginate by the system 12 is controlled through controller 22. The controller 22 is in communication with the motor 32 for providing incremental movement of the motor 32 and hence auger 30. In one configuration, the motor 32 comprises a stepper motor or other similar type motor configured for providing incremental rotation of a drive shaft connected to auger 30. In one mode of operation, based upon system requirements of hydrated alginate, the controller 22 causes rotation of the auger 30, via motor 32, to dispense metered alginate into the mixer assembly 14 where additional fluid, such as water, is dispensed. In one configuration, activation of motor 32 is further based upon fluid level of hydrated alginate within reservoir 16.

In one exemplary embodiment, the system 10 includes one or more weight sensors 33 for monitoring the volume of dry alginate within the hopper 28. The weight sensors 33 are in communication with the controller 22 and may be calibrated based upon the weight of the hopper 28 and any other equipment attached thereto. The weight sensors 33 are configured for generating signals and/or audio or visual indicia for providing indication of the volume of dry alginate within the hopper 28. Based upon these signals, in one embodiment, the controller 22 is configured for generating signals, e.g. audio, visual or both, for providing indication of the volume of dry alginate within the hopper. In another configuration, the controller 22 is configured for initiating a deposit of additional dry alginate into the hopper 28 based upon the signals generated by the weight sensors 33. In this configuration, dry alginate is automatically dispensed into the hopper from the alginate supply 11, such as through a conduit or otherwise.

The mixer assembly 14 is configured for receiving dry alginate from the dry alginate storage and dispense system 12 and fluid, i.e. water from the water supply 13, for hydration of the dry alginate. The mixer assembly 14 is further configured for mixing the dry alginate with the fluid to form a mixture 15 and delivery of the resulting hydrated alginate mixture 15 to reservoir 16. The mixer assembly 14 of the present invention provides thorough mixing of the dry alginate and fluid to cause hydration of the dry alginate at a reduced time interval, as compared to many prior mixing devices. Further, the mixer assembly 14 is further configured to provide automatic dispensing of the hydrated alginate mixture 15 into the reservoir 16. The automated dispensing is such that only substantially hydrated alginate is dispensed into reservoir 16.

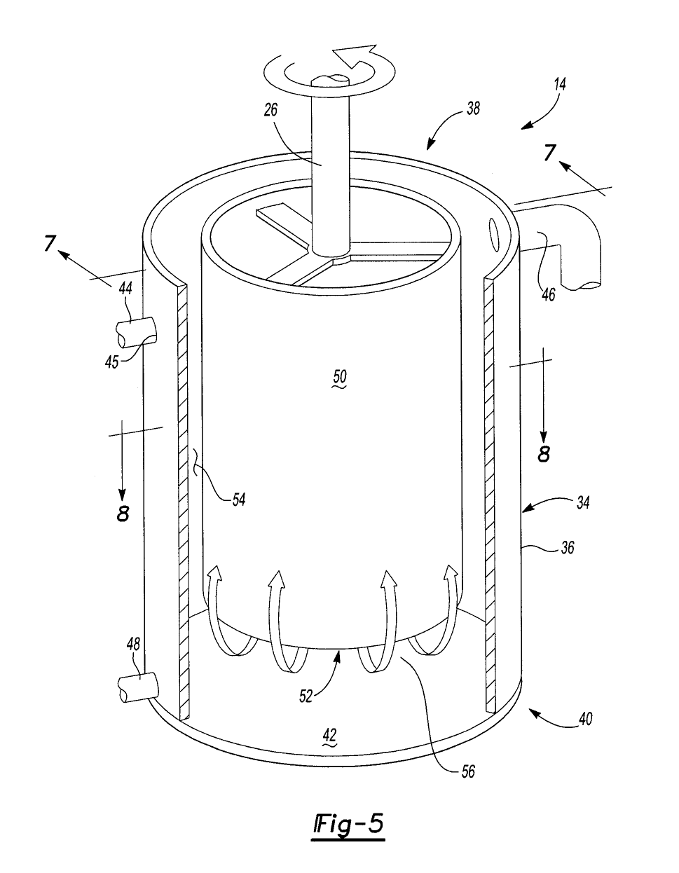

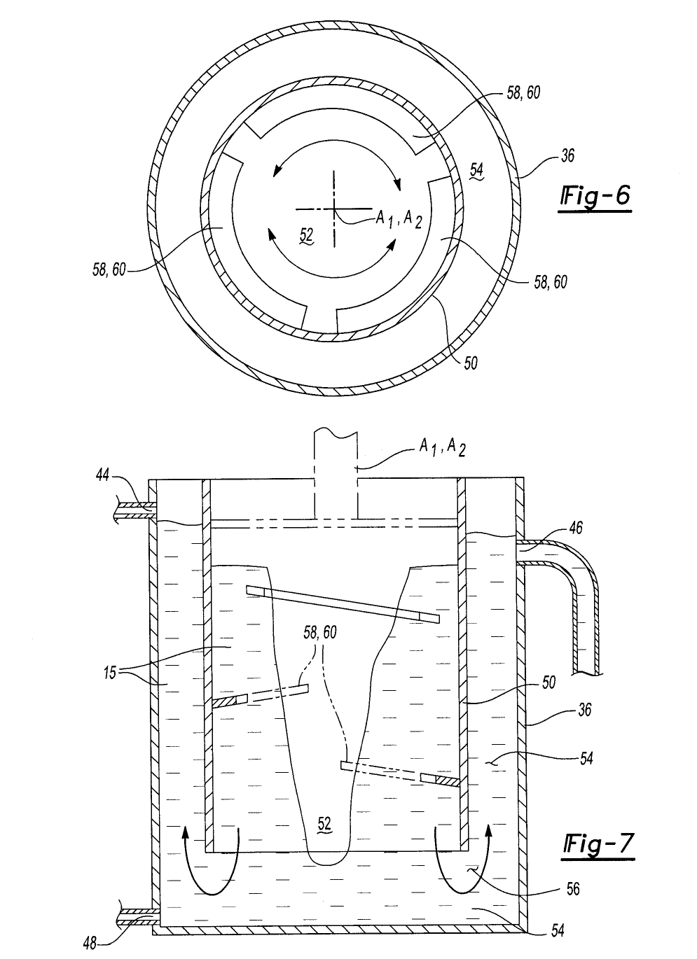

In the exemplary embodiment shown in FIGS. 5 through 7, the mixer assembly 14 includes a container 34 for receiving and mixing dry alginate. The container 34 includes a container wall 36, that extends annularly about a center axis ‘A1’, and between a first end 38 and second end 40. The container 34 further includes a base 42 disposed at the second end 38 for receiving and holding the dry alginate and liquid. In one embodiment, the container 34 comprises a hollow cylindrical member.

The container 34 includes a hydration port 44 disposed through a container wall 36 proximate the first end 38 for receiving fluid, e.g. water from water supply 13 or otherwise, for hydration of dry alginate disposed therein. Fluid flow into the container 34 is controlled through a metering device 45 in communication with the controller 22 for controlling the flow of fluid into the container. The metering device 45 may comprise any suitable valve or other metering device. The container 34 also includes a mixture port 46, disposed proximate the first end 38 or between the first and second end 38, 40, for dispensing hydrated and mixed alginate from within the container 34. The container 34 still further includes a dump port 48 disposed through the container wall 36 proximate the second end 40 for dispensing remnants left within the container 34 such as upon completion of use, cleaning or maintenance of the container or otherwise.

The mixer assembly 14 further includes a partition wall 50 disposed within container 34 and extending between the first and second end 38, 40. In one embodiment, the partition wall 50 is cylindrical in shape and includes a center axis ‘A2’ that is generally aligned with the center axis ‘A1’ of the container 34. The partition wall 50 divides the container 34 into a first chamber 52 disposed within the partition wall and a second chamber 54 disposed between the partition wall 50 and container wall 36. In one exemplary embodiment, a fluid port 56 is formed between the first and second chamber 52, 54 for providing fluid flow therebetween. In one particular configuration, the fluid port 56 is formed through a spaced relationship, such a gap, formed between the partition wall 50 and base 42.

The mixer assembly 14 further includes one or more fins 60 or other extensions 58 configured for mixing ingredients, e.g. alginate and water, within the first chamber 52. In one exemplary embodiment, the extensions 58 extend between the partition wall 50 and center axis ‘A2’ of the partition wall. In this configuration, the extensions are attached to the partition wall 50 and extend towards the center axis ‘A2’ of the partition wall. In another exemplary embodiment, the extensions extend radially about first chamber 52 and about the partition wall 50. In still another exemplary embodiment, the extensions extend towards the second end 40 of the container 34 such that upon rotation of the extensions 58 fluid within the first chamber 52 is directed towards the second end 40 of the container 34, through the fluid port 56, and into the second chamber 54. In yet another exemplary embodiment, the extensions may be tilted towards the first or second end 38, 40 to improve mixing within the first chamber 52. It should be appreciated that any of the above mentioned embodiment features may be combined.

In one preferred embodiment, the extensions 58 comprise fin members 60 extending from the partition wall 50 towards center axis ‘A2’. In this configuration, the fin members 60 extend radially about the second axis ‘A2’ and towards the second end 40 of the container 34 such that with suitable rotation, i.e. either clockwise or counter-clockwise, the mixture 15 within the first chamber 52 is directed towards the second end 40 of the container and through fluid port 56. Advantageously, this configuration generates a fluid vortex within the first chamber 52 that provides improved mixing of the fluid and alginate within the first chamber 52. Further, the vortex generates a downward fluid force thereby moving the mixture 15 from the first chamber 52 to the second chamber 54, via fluid port 56. As fluid continues to enter the second chamber 54, the level of fluid within the second chamber continues to rise until it reaches the mixture port 46 where it is discharged into the reservoir 16. By the time the mixture 15 reaches the mixture port 46 the mixture is substantially mixed.

The extensions 58 are connected to a rotation device, such as a mixer motor 62, to cause mixing within the first chamber 52. In one exemplary embodiment, the partition wall 50 is driveably connected to the mixer motor 62 to cause rotation of the partition wall and extensions 58. The mixer motor 62 may be configured for both clockwise and counter-clockwise rotation; however, in one preferred configuration the mixer motor 62 is configured to cause rotation of the extension so as to generate a fluid vortex within the first chamber 52. In one exemplary embodiment, the mixer motor 62 is in communication with controller 22 for controlling operation, e.g. rotational direction, speed or otherwise, of the mixer motor 62.

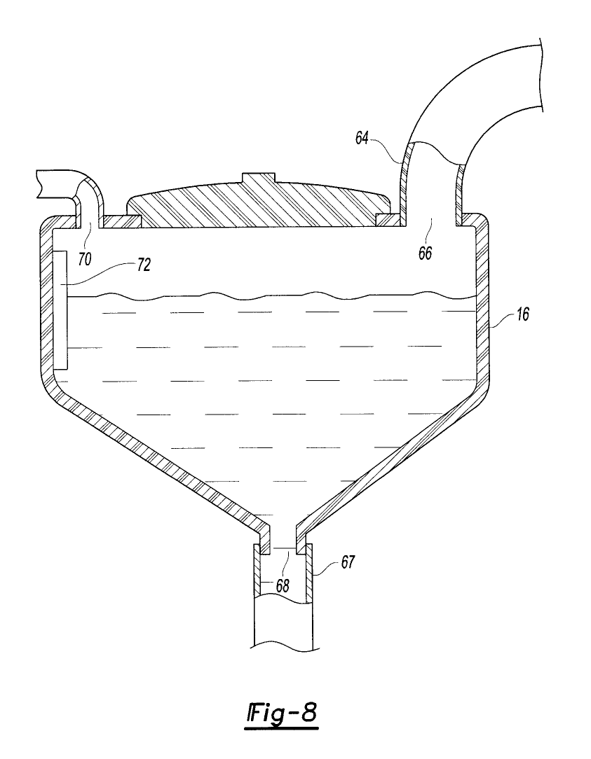

Referring to FIG. 8, in one exemplary embodiment, the reservoir 16 is in fluid communication with the second chamber 54 such that when fluid within the second chamber reaches the height of the mixture port 46 it is discharge into reservoir 16, via conduit 64, and enters the reservoir through input port 66. The reservoir 16 further includes an output port 68 for discharge of the mixture to the fluid delivery device 18. The output port 68 is connected to the fluid delivery device 18 via conduit 67. In one exemplary embodiment, the reservoir 16 further includes a return port 70 for receiving fluid from the fluid delivery device 18. In this embodiment, in certain circumstances, such as short or long term interruption in the delivery of fluid to a forming device 20, it is advantageous to rout fluid from the fluid delivery device 18 back to the reservoir 16, via return port 70, as opposed to cessation of operation of the fluid delivery device. Advantageously, this provides the ability to maintain mixture of the fluid and to provide fluid to the forming device 20 in an expeditious manner without ramp-up time in fluid flow. Further, maintaining operation of the fluid delivery device 18 better ensures the flow rate of material to the forming device 20 over a specified time period. Routing of the fluid from the fluid delivery device 18 to the reservoir 16 is achieved through a valve, such as a solenoid valve, in communication with the controller 22.

In one exemplary embodiment, the reservoir 16 includes a fluid level sensor 72 for monitoring the fluid level within the reservoir. The fluid level sensor is configured for generating a signal based upon the level of fluid within the reservoir 16. In one exemplary embodiment, the fluid level sensor 72 is in communication with controller 22. Communication between the fluid level sensor 72 and controller 22 provides an indication to the controller whether the reservoir 16 is in need for additional mixture 15. Should the sensor 72 provide and indication to the controller 22 of a low fluid level, the controller activates motor 32 to dispense dry alginate into the container 34 and actives the metering device 45 to allow fluid to flow within the container. The controller 22 further actives the mixer motor 62 to mix the ingredients within the first chamber 52 to mix and hydrate the alginate wherein the resulting mixture 15 is dispensed into the reservoir 16, via mixture port 46 and input port 66. The fluid level sensors 72 may comprise any suitable fluid level sensor. Examples of suitable fluid level sensors 72 include hull sensors or otherwise.

Referring again to FIGS. 3 and 4, the fluid delivery device 18 is configured to pump mixture 15 from the reservoir 16 to the forming device 20. In one exemplary embodiment, the fluid delivery device 18 comprises a positive displacement pump. Two types of positive displacement pumps useable with the present invention include rotary and reciprocating pumps. The positive displacement pump 18 displaces a known quantity of liquid with each revolution of the pumping elements. This is achieved by trapping liquid between the pumping elements and a stationary casing. During operation, the reservoir 16 feeds the positive displacement pump with a continuous supply of mixture.

In one exemplary embodiment, the system 10 further includes a fluid heater 74 for supplying heated fluid to the mixer assembly 14, via hydration port 44. The fluid heater 74 is fluidly disposed between a fluid supply, such as water supply 13, and the mixer assembly 14 and heats the fluid to a predetermined temperature. In one exemplary embodiment, the fluid heater 74 comprises an electric heater. However, it is possible to utilize a gas or other heating device as well.

The temperature of the heated fluid can be based upon flow rate of fluid through the fluid delivery device. For example, during high rates of mixture usage by the forming device 20, the fluid entering into the container 34 of the mixer assembly 14 is heated to increase hydration and mixing of the dry alginate with the heated fluid. The fluid heater 74 is in communication with the controller 22 for activating and controlling the temperature of the fluid entering the container 34 of the mixer assembly 14. As the controller 22 is in communication with the fluid deliver device 18 and/or forming device 20, the temperature of the fluid entering the mixer assembly 14 can be based upon the production rate or pelletization through the forming device. It is contemplated that the fluid entering the mixer assembly may be heated to a temperature of about 85° F. to about 145° F. or otherwise.

In one exemplary embodiment, the system 10 further includes a filtration system 76 for removal of particulate matter within mixture 15. The filtration system ensures predominantly only hydrated alginate enters the forming device 20 thereby improving efficiency of the system 10. In one exemplary embodiment, the filtration system 76 is disposed downstream from the fluid delivery device 18. In another exemplary embodiment, the filtration system is disposed between the reservoir 16 and fluid delivery device 18.

In another exemplary embodiment, the system 10 further includes a fluid flow meter 78 for monitoring fluid flow to the forming device 20. The fluid flow meter 78 is in communication with the controller 22 for providing indication of the amount of mixture being pumped to the forming device 20. The fluid flow device is fluidly disposed downstream from the fluid delivery device 18.

Referring to the exemplary embodiments shown in FIGS. 2 and 3, is contemplated that the controller 22 is configured to be in communication with one or more components of the system 10 and selectively control the operation of such components. Through this interaction, the present invention provides an automated system 10 for the hydration and delivery of lubricant and retention agent to the ingredients of a forming device 20 so as to improve efficiency of the system by reducing excess product and improving pellet quality.

The following is a description of one exemplary controller 22 according to the teachings of the present invention. However, it should be appreciated that more or less components may be use.

The controller 22 includes variable frequency drives that are in communication with a programmable logic controller (PLC) to control the variable frequency of drives, such as the rotation drive of any alginate auger or dispenser, mixing motor, pumps or other variable frequency devices. The programmable logic controller (PLC) acts as a typical PLC to perform calculations and control operational conditions of the system such as rotation of augers, mixers, pumps or otherwise, opening and closing of valves, etc. The PLC is in communication with an interface/remote unit 104 to effectuate desired operating conditions of the system as selected by a user.

The controller 22 further includes frequency drive protectors communicatively disposed between the variable frequency drives and a power supply to protect current overloading of the system. In the exemplary embodiment shown, each variable frequency drive is in communication with a frequency drive protector.

The controller 22 also includes manual motor starters for activating components of the systems, such as the motors activated through the variable frequency drives. In the exemplary embodiment shown, each motor includes a manual motor starter for short circuit and overload protection for each of the motors. In one configuration, the manual motor starters 84 are configured to provide over-current protection to the motors.

The controller further includes one or more control relays for activating one or more electrical devices of the system. The controller further includes one or more conductive level sensing modules that are in communication with the fluid level sensor for analyzing and determining the fluid level within the reservoir 16. The controller further includes interface relays and wiring connectors for providing communication between various electrical components of the controller. The controller includes one or more power supplies for providing power to the components of the controller system. In one configuration, a 120 watt DC power supply is provided for device operation and a 30 watt DC power supply is provided for PLC power. It should be appreciated that other configurations are possible. The controller further includes one or more fuse blocks and circuit breakers for protecting the controller from undesirable current levels. Also, in one exemplary embodiment, a disconnect switch or panel is provided for disconnecting the controller and system from an external power supply.

The controller further includes a weight sensor display/control unit 106. The weight sensor display/control unit 106 is in communication with the weight sensors 33 to display the amount of dry alginate within the hopper. The weight sensor display/control unit may be in communication with the dry alginate supply for causing dispensing of additional dry alginate into the hopper. Communication and power of the weight sensor display/control unit may be achieved or assisted by controller 22.

As previously mentioned, in one exemplary embodiment, the controller 22 includes or is in communication with an interface/remote unit 104. The interface/remote unit allows a user to interact with the system, via the controller 22, to both monitor operation of the system and control certain aspects of the system. For example, the interface/remote 104 unit allows a user to monitor flow rate of the mixture to be pumped to a forming device, the amount of dry alginate and fluid dispensed into the mixer assembly, the temperature of the fluid entering the mixer assembly or the mixer being pumped to the forming device of the mixture, or otherwise. In one exemplary embodiment, the interface/remote unit 104 is configured to provide messages to indicate proper or improper operating conditions. Still further, in another exemplary embodiment, the interface/remote unit is configured to monitor operation conditions of the forming device. Such messages may be visual, audible or both.

Also, in another aspect, the interface/remote unit 104 allows a user to manually control certain aspect of the system such as volume ratio of water to alginate being dispensed into the mixer, volume flow rate of mixture being pumped to the forming device, temperature of fluid entering the mixer assembly, or otherwise. In one exemplary embodiment, the system may be controlled remotely through a remote unit disposed at a remote location to that of the system 10.

In one mode of operation, the controller 22 initiates injection of water into the first chamber 52 via a metering device 45, such as through a valve or otherwise. The controller 22 further initiates operation of motor 32 for rotation of auger 30 to dispense dry alginate into the first chamber 52. The controller 22 may also be in communication with a dry alginate supply 11 to initiate filling of the hopper 28. The ratio of water to dry alginate is proportionate to obtain a desired ratio. The controller 22 activates the mixer motor 62 to cause rotation of the extensions 58, via partition wall 50. As the fins 60 rotate, the water and dry alginate mix causing hydration of the alginate and forming mixture 15. Further, a vortex is generated generally about the center axis A1, A2 of the container and/or partition wall 50 to further enhance mixing/hydration of the alginate and generates a downward force causing the mixture 15 to exit the first chamber 52 and enter the second chamber 54, via fluid port 56. As the level of mixture reaches the mixture port 46, the mixture exits the mixer assembly 14 and enters the reservoir 16, via conduit 64.

Based upon operation of the forming device 20, the controller 22 initiates the fluid delivery device 18 to pump fluid to the forming device. This may comprise initiation of operation of the fluid delivery device 18 or redirection, via a valve, of fluid from the fluid delivery device to the forming device. In either regard, fluid is provided to the fluid delivery device 18 from the reservoir 16. The volume flow rate of fluid pumped by the fluid delivery device 18 to the forming device 20 is based upon one or more factors including volume form rate of articles, i.e. pellets, by the forming device, compression load being applied to ingredients within the forming device, temperature of ingredients within the forming device, characteristics or configuration of dry or hydrated alginate (e.g. viscosity, lubricity, temperature, percentage of dry alginate added to a hydration means, type of alginate or otherwise), or otherwise. Accordingly, in one embodiment the controller 22 is in communication with the forming device 20 for determining the flow rate of mixture needed to effectively lubricate and retain the ingredients of the articles together.

As the fluid delivery device continues to provide mixture to the forming device, it is anticipated that the level of mixture within the reservoir 16 decreases. Once the mixture level within the reservoir reaches a predetermined level, fluid level sensor 72 generates a signal that is received by the controller indicating that the fluid level within the reservoir is low. The controller 22 then causes additional dispensing of dry alginate and fluid, i.e. water, into the container 34 where additional mixture is formulated and deposited into the reservoir 16, via conduit 64. It should be appreciated that additional steps may be included with the above described mode of operation as described herein such as heating the fluid entering the first chamber 52 or otherwise.

Alginate provided to the hydration, storage and dispensing system 10 may include known types of alginate. As background, the following is a general description of alginate including preparation thereof. However, it should be appreciated that other methods and types of alginate may be used with the present invention.

Alginates are a natural linear polysaccharide polymers extracted from various species of brown seaweeds (Phaeophyceae) including but not limited to the following species: Laminaria hyperborea, Laminaria digitata, Laminaria japonica, Ascophyllum nodosum, Ecklonia maxima, Lessonia trabeculata, Lessonia nigrescens, Macrocystis pyrifera, and Durvilleae antartica. The wet or dry seaweed is milled, washed, and the alginate extracted into a solution with hot alkaline water. This crude alginate solution is clarified (centrifugation/filtration) and the alginate precipitated as insoluble calcium alginate by the addition of calcium chloride solution. The separated calcium alginate is washed with dilute hydrochloric acid, which converts the insoluble calcium alginate into insoluble alginic acid, while washing out any soluble impurities. The separated pure alginic acid is pasted with an equivalent amount of sodium carbonate to yield sodium alginate, which is dried and milled to a powder. Other carbonate salts may be used to produce, for example, potassium alginate, ammonium alginate, etc. Also, alginates can be esterified with propylene oxide to produce propylene glycol alginate (PGA).

This present invention utilizes any soluble or solubilized alginate salt, including but not limited to sodium alginate, potassium alginate, ammonium alginate, and PGA. In one preferred embodiment, the alginate comprises sodium alginate. Although it is preferred to use pure alginates, the soluble or solubilized alginate does not have to be purified, and the term “alginate” used herein also includes (a) partially purified alginates, for example, the alginate extract being unclarified (not centrifuged or filtered) or partially clarified (centrifuged but not filtered), or (b) seaweed pasted with alkaline water.

Sodium alginate is a commercially available product often sold by vendors in a powder form. Sodium alginate can be found under trade names such as alginic acid sodium salt, sodium polymannuronate, algin, alginate KMF, algiline, Amoloid®, amnucol, antimigrant C45, cecalgine TBV, Collatex®, Dadrid QH, Dariloid QH, Halltex, Kelacid®, kelco gel LV, Kelcoloid LVF, Kelcosol®, Kelgin®, kelgin LV, Kelgin MDH, Kelgin LDH, kelgum, Kelmar®, kelset, Kelset® keltex, keltone, Keltone® LVCR, Keltone® HVCR, Keltose®, Kelvis®, Lacticol®, manucol, Manucol® LKX, Manugel® LBA, manutex, minus, monason, nouralgine, pectagline, proctin, protanal, protatek, snow algin H, Salmuf, Sahmup, Salmup, Sodium/Calcium alginate, stipine, tagat, Textureze™, tragaya, Welgum®, or otherwise

The linear molecular structure of alginates comprises primarily saccharide units of guluronic acid (G) and mannuronic acid (M). Alginates are copolymers of these G and M uronic acid units, and the ratio of G:M and sequencing of the G and M units vary significantly by seaweed species, and also between stipe and frond within the same species. The ratio of G:M varies between 10:90 to 75:25, and sequencing includes G-blocks, M-blocks, MG-blocks, single G, and single M, all these being randomly distributed along the molecular chain. In general, the higher the G content the higher the potential for gelation (gel strength). High M content alginates have low gel potential. The preferred sodium alginate for this invention would have high M content and low G-block content, but any soluble or solubilized alginate can be used irrespective of G:M ratio and sequencing.

Commercial alginates have a degree of polymerization in the range 50-3,000 units, corresponding to molecular weight (Mw) range of 10-600 kDa, with most being in the range 100-400 kDa. Alginate molecular weight is normally expressed as a viscosity measurement using equipment such as a Brookfield Viscometer. A 1% solution of sodium alginate at 25° C. would typically be between 100-1,000 mPas⁻¹. In one preferred embodiment, viscosity range for the sodium alginate used with the present invention is between about 300-400 mPas⁻¹. However, any soluble or solubilized alginate can be used simply by adjusting the alginate concentration to give the desired process viscosity, increasing the concentration for lower Mw alginates, and decreasing the concentration for higher Mw alginates.

Sodium alginates are sensitive to calcium ions (Ca⁺⁺). As the calcium content of a sodium alginate solution is increased, the solution starts to thicken, followed by the formation of thixotropic mixtures, and eventually gelation. Sodium alginates are impacted by water hardness, which varies generally between 50-350 ppm as CaCO₃. High M alginates are not significantly impacted by change of water hardness over this range, with minimal increase of solution viscosity, and are preferred for this invention. High G alginates are significantly impacted by change of water hardness over this range, but can be used in this invention when using soft water (0-100 ppm as CaCO₃). High G alginates can be used in this invention with hard water by the addition of suitable sequestrants (e.g. sodium tripolyphosphate or sodium hexametaphosphate) to decrease Ca⁺⁺ activity. However, any soluble or solubilized alginate can be applied in this invention simply by adjusting the Ca⁺⁺ activity of the alginate solution in line with the water hardness being used to prevent gelation and retain the sodium alginate solution in the thickening or partial thixotropic phases.

Hydration and solubilization of sodium alginate is best achieved by adding the alginate powder to water with high shear to avoid lumping. The use of heat will increase the rate of solubility. Although the use of high shear is not essential for hydration and solubility, it is preferred to ensure consistency and compatibility with the process needs of this invention. Although any high shear equipment can be applied (e.g. Silverson mixer), the preferred equipment is the inline mixer described next.

The resulting mixture formed by the mixer assembly 14, which is stored in the reservoir 16, is based upon desired characteristics of the resulting articles formed by the forming device 20 such as adhesion qualities, resulting pellet quality (i.e. fine reduction, humidity resistance or otherwise). The resulting mixture may also be based upon desired characteristics of the forming process such as desired compression to the ingredients forming the articles, lubricity to the components of the forming device (such as die or otherwise), viscosity of mixture, or otherwise. The resulting mixture 15 may be further based upon the application method to the ingredients such at whether the mixture is applied directly to the ingredient or mixed with another additive such as steam from steam supply 17 or otherwise.

The resulting mixture may include between about 0.1% to 10% of alginate, by weight, of the mixture (e.g. alginate and hydrating agent). However, it is also contemplated that the retention agent may include about 0.5% to 5% of alginate, by weight, or even about 0.25% to 3% of alginate, by weight. Other contemplated ranges includes between about 0.1% to 0.25%, 0.25% to 3%, 3 to 4%, by weight, of the retention agent. It should be appreciated that the percent of alginate of the mixture, and hence the thickness, flowability and viscosity of the second mixture, may depend upon a given form or method of application of the mixture 15 to the ingredients.

The resulting mixture 15 may include one or more additional features or ingredients. For example, while the alginate is contemplated for retaining the ingredients of the articles, alone, it does not foreclose the use of alginate with other retention agents including, but not limited to, traditional retention agents such as starches. Other additional ingredients may include dyes, fragrances, flavors or combinations thereof. Still other potential ingredients may include surfactants or emulsifiers, gums, or combinations thereof. For example, the retention agent may include one or more of the following ingredients: sodium alginate, water, surfactant, growth promoter, mold inhibitor, hormones, steroids, coloring agents, odor agents, taste agents, or otherwise.

It is contemplated that components of the system 10, such as fluid heater 74, may affect that characteristics of the mixture and hence further affect the above referenced desired characteristics. Further, other factures such as alginate type, percentage weight of alginate within the mixture, additives or otherwise may also affect the above desired characteristics. In one embodiment, the controller 22 is configured for receiving information pertaining to the characteristics of the mixture to determine the volume flow rate of mixture to be applied to ingredients forming the articles.

For example, as the temperature of the mixture is increased, the viscosity of the mixture decreases potentially effecting absorbability of the mixture into the ingredients forming the articles. In another example, as certain additives are introduced into the mixture, the resulting viscosity of the mixture also changes. Accordingly, it is contemplated that the controller 22 of the present invention is capable of continuous change based upon the characteristics of the mixture and flow rate of ingredients through the forming device to ensure desired effect upon the resulting articles, i.e. pellets.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

1. An alginate hydration, storage and dispensing system for a pellet forming device, the system comprising:
a storage and dispense system configured for receiving and dispensing dry alginate;
a mixer assembly configured to receive dry alginate from the storage and dispense system, the mixer assembly includes:
a container including an annular wall and a base, the container further includes a hydration port for receiving fluid from a hydration supply and a mixture port for dispensing a fluid mixture from within the container,
a rotatable partition wall disposed within the container, the partition wall defines a first chamber formed within the partition wall and a second chamber formed between the partition wall and annular wall, wherein the partition wall is displaced with respect to the base of the container to form a fluid flow path between the first and second chamber,
one or more fin members disposed about a center portion of the partition wall, and
a mixer motor engaged with the partition wall to cause rotation of the one or more fin members, wherein upon rotation the one or more fin members are configured to generate a fluid vortex within the first chamber to cause fluid movement from the first chamber to the second chamber;
a reservoir in fluid communication with the mixture port of the container to receive the fluid mixture from the second chamber;
a pump in fluid communication with the reservoir configured to pump the fluid mixture from the reservoir to a pellet forming device; and
a controller in communication with the storage and dispense system and mixer assembly to provide a continuous supply of the fluid mixture to the pump.

2. The system of claim 1, further comprising a heater fluidly disposed between the hydration supply and hydration port to warm fluid entering the container of the mixer assembly.

3. The system of claim 2, wherein the controller is in communication with the heater to cause selective warming of fluid entering the container to a temperature between about 85° F. to about 140° F.

4. The system of claim 1, further comprising one or more weight sensors for monitoring an amount of material within a hopper of the storage and dispense system.

5. The system of claim 4, wherein the controller is in communication with the one or more weight sensors and generates an indicia of the amount of material within the hopper.

6. The system of claim 1, further comprising a fluid flow meter disposed between the pump and pellet forming device for monitoring mass flow rate of the fluid mixture being pumped from the reservoir to the pellet forming device.

7. The system of claim 6, wherein the controller controls pumping of the fluid mixture based upon measurements taken by the fluid flow meter.

8. The system of claim 6, wherein the controller controls pumping of the fluid mixture based upon known pumping characteristics of the pump.

9. The system of claim 1, further comprising a filter fluidly disposed between the pump and pellet forming device for removal of particulate matter from the mixture.

10. The system of claim 1, further comprising a fluid sensor for generating signals based upon a fluid level within the reservoir.

11. The system of claim 10, wherein based upon signals generated by the fluid sensor the controller causes dispensing of dry alginate and fluid from the hydration supply into the container of the mixer assembly.

12. The system of claim 1, wherein the controller is in further communication with the pellet forming device to monitor performance thereof

13. The system of claim 12, wherein control of the pump is based upon a volume flow rate of pellets being formed by the pellet forming device.

14. The system of claim 12, wherein control of the pump is based upon compression load being applied to pellet ingredients by the pellet forming device.

15. The system of claim 1, wherein control of the pump is based upon calculated viscosity of the fluid mixture.

16. The system of claim 1, wherein control of the pump is based upon calculated or anticipated lubricity of the fluid mixture.

17. The system of claim 1, wherein the mixer assembly includes a plurality of fin members extend radially about the center portion of the partition wall.

18. The system of claim 17, wherein the plurality of fin members are attached to the partition wall and extend inwardly towards the center portion of the partition wall.

19. The system of claim 18, wherein the one or more fin members form a helical or partial helical shape about the center portion of the partition wall.

20. A method of providing a continuous supply of hydrated alginate to a forming device, comprising the steps of:
i) providing a source of dry alginate;
ii) providing a source of hydration fluid;
iii) providing a mixer assembly including;
a container defined by an annular wall and a base, the container including a dispensing port for dispensing a fluid mixture to a reservoir which is in fluid communication with a fluid pump,
a partition wall disposed within the container, the partition wall defines a first chamber formed within the partition wall and a second chamber formed between the partition wall and annular wall,
one or more fin members disposed about a center portion of the partition wall and within the first chamber,
iv) dispensing dry alginate and hydration fluid into the first chamber of the container;
v) rotating the partition wall to generate a fluid vortex within the first chamber to cause mixing of the dry alginate and hydration fluid to form a fluid mixture and generate movement of the fluid mixture from the first chamber to the second chamber and further through the dispensing port and to the reservoir; and
vi) pumping the fluid mixture from the reservoir to the forming device.
